(19) United States
(12) Patent Application Publication
(10) Pub. No.: US 2011/0182336 A1
(43) Pub. Date: Jul. 28, 2011

(54) METHOD FOR DETERMINING A SIGNAL VECTOR AND DETECTION CIRCUIT

(75) Inventors: Woon Hau Chin, Singapore (SG); Sumei Sun, Singapore (SG); Po Shin Francois Chin, Singapore (SG); Chau Yuen, Singapore (SG); Peng Hui Tan, Singapore (SG)

(73) Assignee: AGENCY FOR SCIENCE, TECHNOLOGY AND RESEARCH, Singapore, SG (SG)

(21) Appl. No.: 12/740,668

(22) PCT Filed: Sep. 19, 2008
(86) PCT No.: PCT/SG2008/000354

§ 371 Date: Apr. 19, 2011

Related U.S. Application Data
(60) Provisional application No. 60/983,661, filed on Oct. 30, 2007.

(51) Int. Cl. H04B 17/00

(52) U.S. Cl. 375/224

(57) ABSTRACT

A method for determining a signal vector comprising a plurality of components from a received signal vector is provided comprising generating an estimation of the signal vector; determining a channel matrix characterizing the communication channel via which the signal vector was received; carrying out a plurality of determination iterations based on the channel matrix, wherein for each iteration a first set of possible sub-vectors of the signal vector is determined based on a second set of possible sub-vectors for the previous iteration and from the first set of possible sub-vectors, a number of sub-vectors is selected based on the distance of the sub-vectors to the estimated signal vector according to a pre-selected metric to form a strict subset of the first set as the second set of possible sub-vectors for the iteration; determining the signal vector based on a possible sub-vector for the last iteration.

### FIELD OF THE INVENTION

Embodiments of the invention generally relate to a method for determining a signal vector and a detection circuit.

### BACKGROUND OF THE INVENTION

In a radio communication system where multiple transmit antennas and multiple receiver antennas are used the detection of transmitted symbols plays a large role for the performance of the communication system. Optimal and near-optimal detection methods may be too complex to be implemented while suboptimal methods may produce unsatisfactory results. Of the low complexity algorithms that have been proposed recently, the QRD-M algorithm is of high interest since near maximum likelihood performance can be achieved with it while having only a fraction of the computational cost of other methods such as sphere decoding. There exist various variants of the QRD-M algorithm which have been proposed to further reduce the complexity.

### SUMMARY OF THE INVENTION

In one embodiment, a method for determining a signal vector comprising a plurality of components from a received signal vector is provided comprising generating an estimation of the signal vector; determining a channel matrix characterizing the communication channel via which the signal vector was received; carrying out a plurality of determination iterations based on the channel matrix, wherein for each iteration a first set of possible sub-vectors of the signal vector is determined based on a second set of possible sub-vectors for the previous iteration and from the first set of possible sub-vectors, a number of sub-vectors is selected based on the distance of the sub-vectors to the estimated signal vector according to a pre-selected metric to form a strict subset of the first set as the second set of possible sub-vectors for the iteration; and determining the signal vector based on a possible sub-vector for the last iteration.

According to other embodiments, a detection circuit and a computer program product according to the method described above are provided.

### SHORT DESCRIPTION OF THE FIGURES

Illustrative embodiments of the invention are explained below with reference to the drawings.

FIG. 1 shows a flow diagram according to an embodiment.

FIG. 2 shows a detection circuit according to an embodiment of the invention.

FIG. 3 shows a communication system according to an embodiment of the invention.

FIG. 4 shows a flow diagram.

FIG. 5 shows a node diagram according to an embodiment.

FIG. 6 shows a flow diagram according to an embodiment.

### DETAILED DESCRIPTION

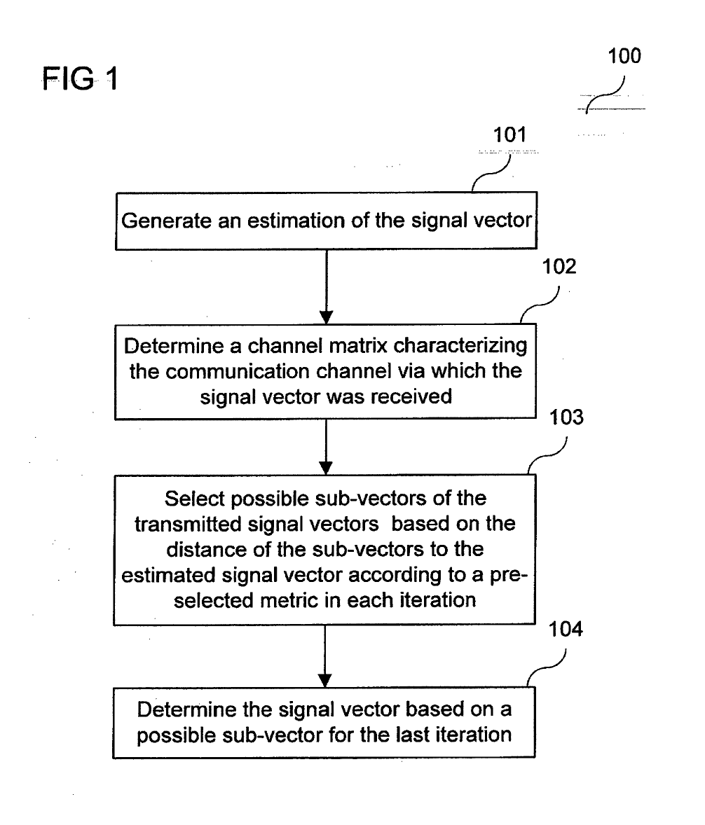

A method for determining a signal vector including a plurality of components from a received signal vector according to one embodiment is illustrated in FIG. 1.

FIG. 1 shows a flow diagram 100 according to an embodiment.

In 101, an estimation of the signal vector is generated.

In 102, a channel matrix characterizing the communication channel via which the signal vector was received is determined.

In 103, a plurality of determination iterations are carried out based on the channel matrix, wherein for each iteration a first set of possible sub-vectors of the signal vector is determined based on a second set of possible sub-vectors for the previous iteration and from the first set of possible sub-vectors, a number of sub-vectors is selected based on the distance of the sub-vectors to the estimated signal vector according to a pre-selected metric to form a strict subset of the first set as the second set of possible sub-vectors for the iteration.

In 104, the signal vector is determined based on a possible sub-vector for the last iteration.

In other words, in one embodiment, in each iteration a subset of possible sub-vectors is selected from all possible sub-vectors determined in this iteration based on the distance to an estimation of the transmitted signal vector, such as a ZF forcing solution or an MMSE solution, generally a vector that can be expected to be close to the transmitted signal vector according to the pre-determined metric. A possible sub-vector is a sub-vector formed based on symbols that could have been transmitted using the transmitted signal vectors, such as modulation symbols possible according to the modulation scheme used for generating the transmitted sub-vector. From iteration to iteration, the dimension of the possible sub-vectors for example is increased such that, in the last iteration, one has one or more candidates for the transmitted signal vector, i.e. vectors that are, taking into account the received signal vector, likely to be equal to the actual transmitted signal vector.

The transmitted signal vector and the received signal vector refer to vectors of transmitted or received signal values, respectively. A signal value may correspond to an antenna, i.e. different components of the transmitted signal vector or the received signal vector have for example been transmitted or received using different antennas. A signal value may also refer to the real part or the imaginary part of a symbol transmitted or received using one antenna such that for example, one component of the transmitted signal vector or the received signal vector corresponds to the real part of a symbol transmitted or received using an antenna and another component of the transmitted signal vector or the received signal vector corresponds to the imaginary part of the symbol. A signal value may be a symbol or a part of a symbol (e.g. the real or imaginary part of a symbol), for example from a set of modulation symbols.

Embodiments that are described in the context of the method for determining a signal vector including a plurality of components from a received signal vector are also valid for the detection circuit and the computer program product.

The estimation of the signal vector is for example generated based on the zero forcing solution or the minimum mean square error solution.

The pre-selected metric is for example the Euclidean distance. The pre-selected metric may also be another distance measure and may also include a weighting of components.

In one embodiment, the determination iterations are carried out based on a QR decomposition of the channel matrix.

The first set of possible sub-vectors is for example determined based on at most a pre-determined number of elements of the second set for the previous iteration. In other words, only a pre-determined number of the sub-vectors determined in one iteration is for example used for the next iteration. For example, the search space (i.e. the number of possible sub-vector candidates) is reduced in this way.

In one embodiment, the second set is formed from the first set such that if a first sub-vector of the first set is selected to be in the second set and there is a second sub-vector in the first set that is closer to the estimated signal vector according to the pre-selected metric then the second sub-vector is also selected to be in the second set.

In other words, in one embodiment, the sub-vectors closest to the estimation are selected and for example used as a basis for the next iteration.

In one embodiment, the possible sub-vectors of an iteration have a dimension that is one higher than the sub-vectors of the previous iteration.

For example, the possible sub-vectors of the first set for an iteration are determined from the sub-vectors of the second set for the previous iteration such that each sub-vector of the first set includes one of the sub-vectors of the second set for the previous iteration as a sub-vector. For example, each sub-vector of the first set includes one of the sub-vectors of the second set for the previous iteration as a sub-vector and an additional component. In other words, for example, the candidate sub-vectors grow from iteration to iteration by one component.

The additional component for example at least partially specifies a possible component of the transmitted signal vector. For example, the additional component at least partially specifies a constellation symbol according to a modulation scheme.

By specifying a component or constellation symbol at least partially could for example mean that it specifies the real part or the imaginary part of the component or constellation symbol.

In one embodiment, the channel matrix includes noise information. The channel matrix is for example generated based on a channel matrix specifying transmission characteristics (e.g. between multiple antennas) and is for example expanded by a noise matrix specifying noise (e.g. channel noise or receiver noise) at the receiver antennas.

For example, the signal vector was transmitted using a plurality of transmit antennas and the received signal vector was received using a plurality of receiving antennas. For each pair of a transmit antenna and a receiving antenna, the channel matrix may for example include information about transmission characteristics between the transmit antenna and the receiving antenna.

Embodiments of the invention may be applied to radio communication systems such as cellular mobile communication systems or wireless local communication systems, for example communication systems according to 3GPP (3^{rd} Generation Partnership Project), FOMA (Freedom of Mobile Access), CDMA2000 (CDMA: Code Division Multiple Access), WLAN (Wireless Local Area Network), etc.

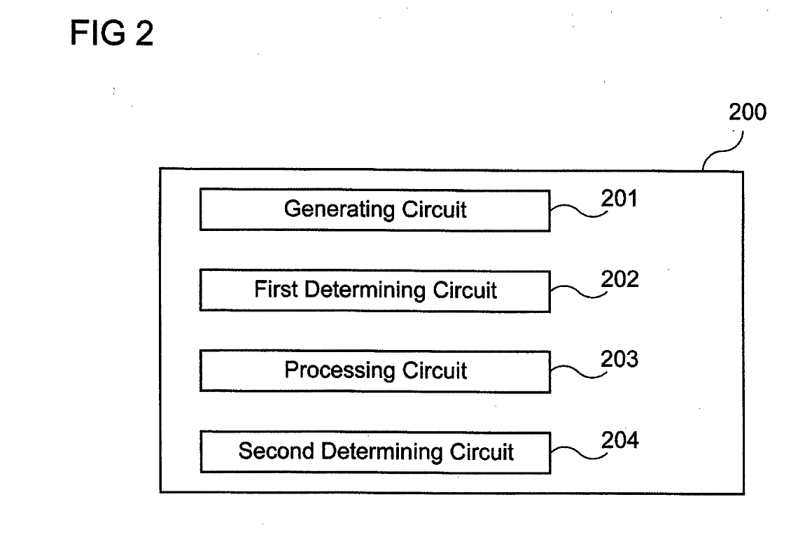

The method illustrated in FIG. 1 is for example carried out by a detection circuit for determining a signal vector including a plurality of components from a received signal vector as shown in FIG. 2.

FIG. 2 shows a detection circuit 200 according to an embodiment of the invention.

The detection circuit 200 includes a generating circuit 201 configured to generate an estimation of the signal vector.

Further, the detection circuit 200 includes a first determining circuit 202 configured to determine a channel matrix characterizing the communication channel via which the signal vector was received.

A processing circuit 203 of the detection circuit 200 is configured to carry out a plurality of determination iterations based on the channel matrix, wherein for each iteration a first set of possible sub-vectors of the signal vector is determined based on a second set of possible sub-vectors for the previous iteration and

from the first set of possible sub-vectors, a number of sub-vectors is selected based on the distance of the sub-vectors to the estimated signal vector according to a pre-selected metric to form a strict subset of the first set as the second set of possible sub-vectors for the iteration.

The detection circuit 200 further includes a second determining circuit configured to determine the signal vector based on a possible sub-vector for the last iteration.

The detection circuit 200 is for example part of a receiver.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

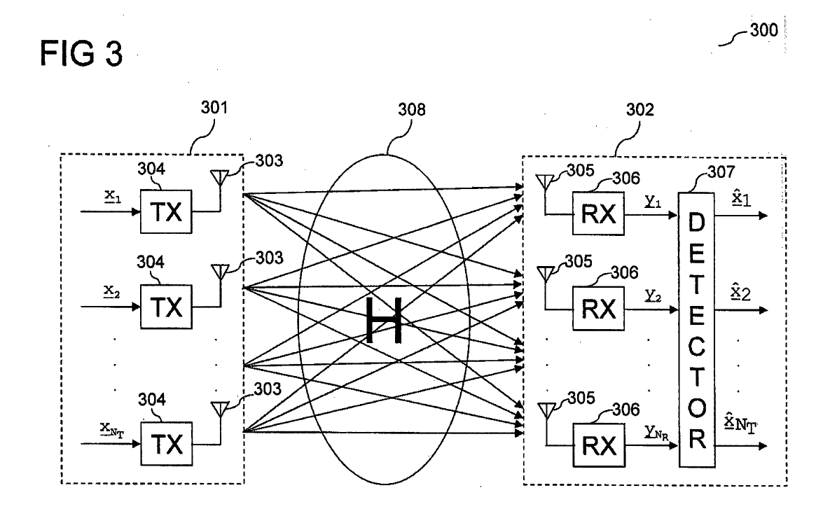

FIG. 3 shows a communication system 300 according to an embodiment of the invention.

The communication system 300 includes a transmitter 301 and a receiver 302. The transmitter 301 includes a plurality of transmit antennas 303, each transmit antenna 303 being coupled with a respective sending unit 304.

Each sending unit 304 is supplied with a component of a signal vector x=[x₁, x₂, . . . , x_{NT}]^{T} where Nₜ is the number of transmit antennas 303. Each sending unit 304 transmits the respective component of the signal vector x using the respective antenna 303, such that altogether, the signal vector x is sent. The transmitted signal vector is received by the transmitter 302 by a plurality of receive antennas 305, each receive antenna 305 being coupled with a respective receiving unit 306 in form of the received signal vector y=[y₁, y₂, . . . , y_{N}_{_{R}}]^{T} via a communication channel 308 (the superscript T denotes transposition). N_{R} denotes the number of receive antennas 305, wherein, for example, N_{T}≦N_{R}.

Since N_{R} and N_{T} are assumed to be both bigger than one, the communication system 300 is a MIMO (multiple input multiple output) system, for example a MIMO-OFDM (orthogonal frequency division multiplexing) system with N_{T}=N_{R}=4 or 8. Modulation is for example done according to PSK (Phase Shift Keying) or QAM (Quadrature Amplitude Modulation), e.g. 16QAM or 64QAM. The transmitter 301 may also include a circuit for encoding (e.g. turbo coding) the data to be sent and may include a bit interleaver. For modulation, gray mapping may be used. The receiver 302 carries out the respective inverse operations, for example bit de-interleaving and turbo decoding.

Each receive antenna 305 receives one component of the received signal vector y and the respective component is output by the receiving unit 306 coupled to the antenna and fed to a detector 307.

The communication channel 308 is for example assumed to be a quasi-static flat fading channel. The transmission characteristics of the communication channel 308 between the transmit antennas 303 and the receive antennas 305 can be modeled by a complex channel matrix H of dimension N_{R}×N_{T}. The component H_{j,i} of H characterizes the transmission (e.g. the path gain) from the ith transmit antenna 303 to the jth receive antenna 305. In one embodiment, it is assumed that the channel matrix H is known to the receiver 302 for example by channel estimation carried out before transmitting the signal vector x.

The received signal vector y can be written as

y=H·x+w (1)

where w=[w₁, w₂, . . . , w_{N}_{_{R}}]^{T} is a vector wherein the jth component represents additive white Gaussian noise (AWGN) with variance σ² at the jth receive antenna.

The signal vector x is for example generated from a single data stream that is de-multiplexed in the transmitter 301 into N_{T} sub-streams. Each sub-stream is encoded into symbols and one symbol of a sub-stream corresponds to a component of the signal vector x.

The detector 307 uses the received signal vector y to generate an estimated signal vector which is an estimate for the originally sent signal vector x.

Applying QR decomposition to H one obtains

H=QR (2)

where Q is an unitary matrix of dimension N_{R}×N_{R} and

$${R}_{\_}^{\hat{}} = [ \begin{matrix}\underline{R} \\ {\underline{0}}_{( {N}_{R} - {N}_{T} ) \times {N}_{T}}\end{matrix} ] \qquad ( 3 )$$

is an upper triangular matrix with R_{j,i}, j≧i being its non-zero elements.

By multiplying the expression of equation (1) with Q^{H} (from the left) where the superscript H denotes the Hermitian operation, equation (1) can be rewritten as

\tilde{y}=Rx+\tilde{w} (4)

where \tilde{y} includes the first N_{T} rows of Q^{H}y and \tilde{w} includes the first N_{T} rows of Q^{H}w.

Since Q is unitary, the maximum likelihood solution is given, after QR decomposition, by

$${{x}_{\_}^{\hat{}}}_{MLD} = arg {min}_{\underline{x} ∈ {Ω}^{{N}_{T}}} {‖ {y}_{\_}^{\sim} - \underline{Rx} ‖}^{2} \qquad ( 5 )$$

where Ω denotes the modulation symbol set for each component, i.e., xᵢ εΩ for all i. In other words, S=Ω^{N}^{_{T}} is the constellation set from which x is chosen.

The multiplication of (1) by Q^{H} gives rise to a tree-like structure (having as nodes possible sub-vectors of the transmitted signal vector x) with a depth of N_{T}.

Hence, tree search techniques like the M-algorithm or the stack algorithm can be applied to detect the transmitted signal vector x since x has been chosen from the finite constellation set S.

The QRD-M algorithm is based on the classical M-algorithm. The concept of the QRD-M algorithm may be seen to apply the multiplication of Q^{H} (which may be seen as a pre-multiplication) before applying the M-algorithm to detect the components of the transmitted signal vector sequentially.

Starting from the last element of the vector x (i.e. the component x_{N}_{_{T}}) the M-algorithm calculates metrics for all possible values of x_{N}_{_{T}} (from the set Ω that has for example C elements) according to

|\tilde{y}_{N}_{_{T}}−r_{N}_{_{T}},N_{T}×N_{_{T}}|² (6)

where r_{N}_{_{T}},N_{T} is the (N_{T}, N_{T}) element of R, i.e. the element in the N_{T}th row and the N_{T}th column. Please note that the components of the vector x may be ordered according to some rule such that any component may be the last component. The metrics according to (6) for these points x_{N}_{_{T}} (i.e. candidate components or generally candidate sub-vectors of x) are ordered and only the M nodes (i.e. the M components) with the smallest metrics are retained. These M nodes are subsequently extended with each node branching out to C nodes (namely according to the C possible values of x_{N}_{_{T-1}} from the set Ω) resulting in MC branches. Only M branches (each branch corresponding to a candidate sub-vector of x, namely a pair x_{N}_{_{T-1}}, x_{N}_{_{T}}) are retained and the rest omitted. The same procedure is applied to the nodes of the next level and the process is continued until a tree depth of N_{T} is reached, i.e. the candidate sub-vectors have dimension N_{T} and are candidate estimates for the transmitted signal vector x.

The metrics of the branches can be calculated by using the QR decomposition reduced maximum likelihood criterion according to equation (5). For tree depth i, with 1≦i≦n_{T}, the metric for a branch is

|\tilde{y}_{N}_{_{T}}−i+1−R_{N}_{_{T}}−i+1xᵢ|² (7)

where \tilde{y}ₖ denotes the kth element of \tilde{y}, Rₖ denotes the kth row of R and x̅ᵢ is the vector of the appropriate nodes of the particular branch, i.e. the candidate sub-vector corresponding to this node.

The QRD-M algorithm can for example be summarized as follows:

1) Perform a QR decomposition of the channel matrix H.
2) Premultiply the received vector y with Q^{H}.
3) Extend all branches to C nodes.
4) Calculate the branch metrics according to (7).
5) Order the branches according to their metrics retaining only M branches and discard the rest.
6) Move to next level and go to 3 (unless already in last, i.e. N_{T}th, level).

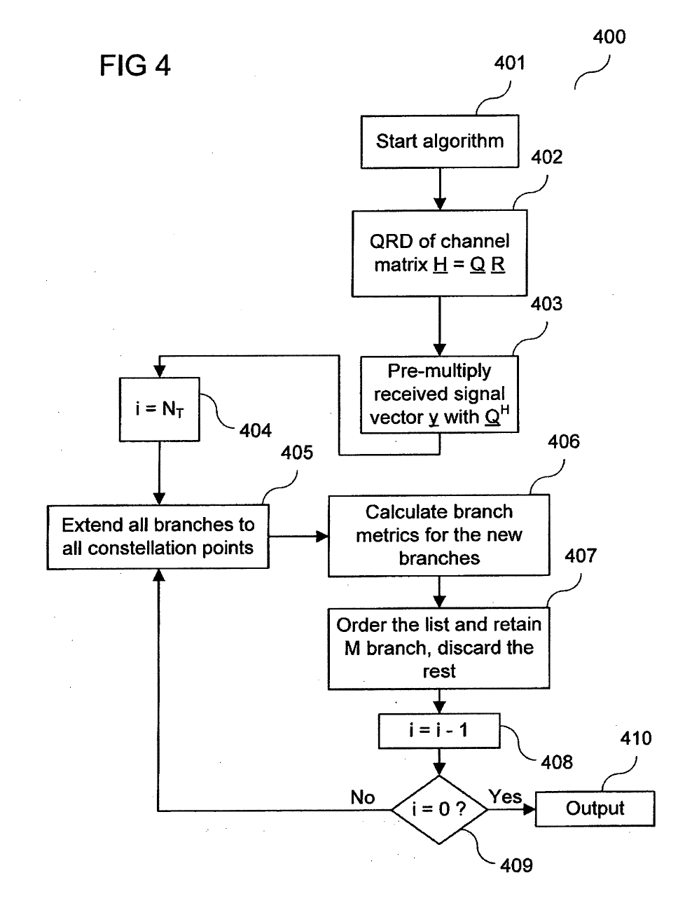

An example for a flow of the QRD-M algorithm is given in FIG. 4.

FIG. 4 shows a flow diagram 400.

In 401, the algorithm is started.

In 402, a QR decomposition of the channel matrix H is performed.

In 403, the received signal vector y is pre-multiplied with Q^{H}.

In 404, an iteration counter i is set to the number of transmit antennas n_{T}.

In 405, all branches are extended according to all possible constellation points.

In 406, branch metrics are calculated for the new (i.e. the extended) branches.

In 407, the list of new branches is ordered according to their metrics and the M branches with the lowest metric are retained. The rest is discarded.

In 408, i is decreased by one.

In 409, it is checked whether i equals zero. If not, the process continues with 405. If yes, the result, e.g. the list of extended branches of the last iteration, is output in 410, e.g. for further processing such as the selection of the detected signal vector from the list according to some selection rule.

In the QRD-M algorithm as described above, all branches are extended regardless of the value of the branch metric. This property may be useful in some cases such as in list type decoding where a list of possible candidates is required for soft decision decoding.

To arrive at a reduced computational complexity compared to the QRD-M algorithm as described above, in one embodiment, some complexity reduction measures are used. For, example, the equations may be re-structured such that the constellations are real-valued (i.e. the components of the processed vectors and sub-vectors are real-valued). For this, equation (1) is for example re-written as

\tilde{y}=\tilde{H}·\tilde{x}+\tilde{w} (8)

where

$${y}_{\_}^{\sim} = [ \begin{matrix} ( \underline{y} ) \\ ( \underline{y} )\end{matrix} ] , {H}_{\_}^{\sim} = [ \begin{matrix} & - ( \underline{H} ) \\ ( \underline{H} ) & ( \underline{H} )\end{matrix} ] , {x}_{\_}^{\sim} = [ \begin{matrix} ( \underline{x} ) \\ ( \underline{x} )\end{matrix} ] , \\ and {w}_{\_}^{\sim} = [ \begin{matrix} ( \underline{w} ) \\ ( \underline{w} )\end{matrix} ] , \qquad ( 9 )$$

[symbol]

(.) with a vector or matrix as argument refers to the vector or matrix (of the same dimension as the argument) having only the real parts of the components of the argument. Similarly, ℑ(.) with a vector or matrix as argument refers to the vector or matrix having only the imaginary parts of the components of the argument.

In one embodiment, instead of y, H, x and w, the vectors/matrix \tilde{y}, \tilde{H}, \tilde{x}, and \tilde{w} are used for the detection algorithm. Thus, the processed vectors (or the processed matrix) have only real components.

Further, in one embodiment, instead of H or H, the matrix

$${H}_{\_}^{\sim} = [ \begin{matrix}{H}_{\_}^{\sim} \\ σ \underline{I}\end{matrix} ] \qquad ( 10 )$$

is used, i.e., for example, the QR decomposition is performed on the matrix Ĥ.

In one embodiment, rather than branching to all constellation points (i.e. to all possible sub-vectors according to the possible signal vector components in Ω), only a pre-determined number K is extended at each depth, i.e. at each iteration (corresponding to a certain sub-vector dimension). The K branches at each depth are for example selected according to their Euclidean distance from

1) the zero forcing (ZF) solution for the transmitted signal vector;
2) the Minimum Mean Square Error (MMSE) solution for the transmitted signal vector;
3) the quantized zero forcing solution or the quantized MMSE solution.

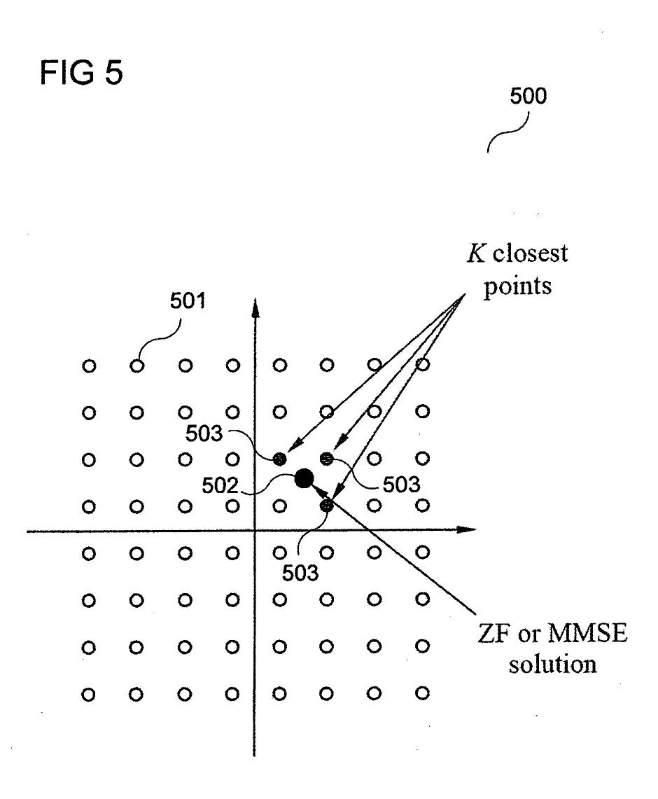

This is illustrated in FIG. 5.

FIG. 5 shows a node diagram 500 according to an embodiment.

The possible nodes 501 in one iteration are illustrated in a two-dimensionally in this example. Further, a pre-estimation 502 of the transmitted signal vector such as the ZF solution or MMSE solution (or a quantized version thereof) is shown. According to one embodiment, the K closest points 503, i.e. the possible nodes (possible candidate sub-vectors) that are closest to the pre-estimation 502 are selected. The distance based on which the candidate vectors are selected is measured according to some metric, e.g. the Euclidean distance or a variant thereof, e.g. including a weighting of components.

The zero forcing solution may be determined based on equation (1) according to

\hat{x}_{ZF}=H^{†}y (11)

and the MMSE solution may be determined according to

\hat{x}_{MMSE}=H^{H}(HH^{H}+σ²I)⁻¹y (12)

where H^{t} is the Moore-Penrose pseudo inverse matrix of H and σ² is the noise variance.

The quantized solution is given by

\hat{x}_{Q}=Q(\hat{x}_{ZF/MMSE}) (13)

where \hat{x}_{ZF/MMSE} is either the MMSE or the ZF solution and Q(.) is a quantization function.

By reducing the search space based on the distance of the candidate sub-vectors to a pre-determined estimation of the received signal vector such as the ZF solution or the MMSE solution or a quantized version of one of these, the list of candidates may be reduced to candidate sub-vectors that are more likely to give rise to the maximum likelihood solution than the others and are thus more likely to contribute to the final candidate list (i.e. the list of candidate vectors for the transmitted signal vector). Only those branches are extended that are more likely give rise to candidate vectors that are close to the maximum likelihood solution.

In one embodiment, a detection algorithm is carried out as summarized as follows:

1) The ZF solution of the MMSE solution (or a quantized version thereof) is determined as an estimation of the transmitted signal vector.
2) A channel matrix is constructed, e.g. the channel matrix H, or the channel matrix \tilde{H} for real-valued processing.
3) The expanded channel matrix Ĥ is determined from the constructed channel matrix.
4) QRD decomposition is applied to Ĥ.
5) The received signal vector y is pre-multiplied by Q^{H}.
6) All branches to the K nodes closest to the ZF/MMSE/Quantized solution are extended.
7) The branch metrics are calculated according to equation (6).
8) The branches are ordered according to their metrics and only M branches are retained while the rest is discarded.
9) It is moved to the next level (next sub-vector dimension) and the process continues with 6 (unless the last level has been reached).

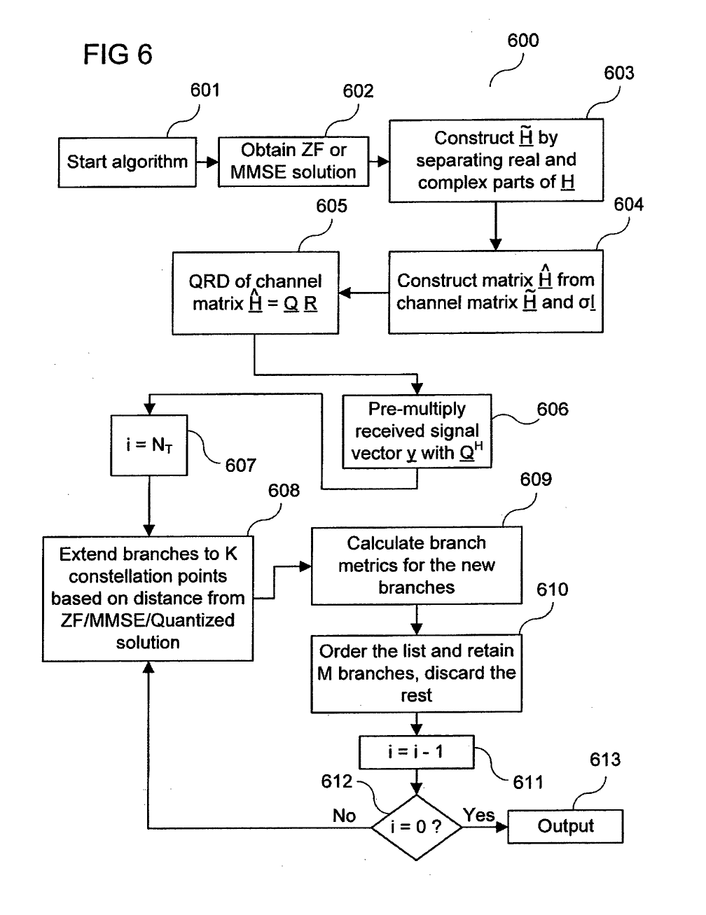

The flow of a detection algorithm according to one embodiment is shown in FIG. 6.

FIG. 6 shows a flow diagram 600 according to an embodiment.

In 601, the algorithm is started.

In 602, the ZF solution or the MMSE solution or a quantization thereof is determined as a pre-estimation of the transmitted signal vector.

In 603, the channel matrix \tilde{H} for real-valued processing is determined by separating the real and complex parts of the components of the channel matrix H.

In 604, the expanded channel matrix Ĥ is determined from the channel matrix \tilde{H} and σI.

In 605, a QR decomposition of the expanded channel matrix Ĥ is performed.

In 606, the received signal vector y is pre-multiplied with Q^{H}.

In 607, the iteration counter i is set to N_{T}.

In 608, all branches are extended to a pre-determined number K of constellation points based on their distance from the ZF/MMSE/quantized solution.

In 609, branch metrics are calculated for the new branches.

In 610, the list of new branches (corresponding to candidate sub-vectors of the transmitted signal vector) are ordered and M branches are retained while the rest is discarded.

In 611, the iteration counter i is decreased by 1.

In 612, it is checked whether i has reached zero. If i has not reached zero, the process continues with 608 (i.e. with the next iteration). If i has reached zero the result, e.g. the list of extended branches of the last iteration, is output in 613, e.g. for further processing such as the selection of the detected signal vector from the list according to some selection rule.

While the computational complexity of the QRD-M algorithm is fixed, the algorithm as e.g. illustrated in FIG. 6 provides more flexibility. The computational complexity of the algorithm is scalable and can be set much lower than the complexity of the complexity of the QRD-M at the cost of reduced performance.

In one embodiment, a signal separation method of separating a plurality of mixed received signals into individual components is provided, including deriving the approximate solution by multiplying the received signals with the respective elements of an estimator matrix; calculating a quantity representing the Euclidean distance between different signal points on a signal constellation diagram, different signals being related to different signal points on said signal constellation diagram, and the approximate solution; and multiplying the received signals with respective elements of a unitary matrix.

The method may further include selecting candidates of the solution based on the result of the calculation; computing the appropriateness of the candidates; ranking the candidates; and selecting candidates based on the ranking. This is for example repeatedly executed.

The method may further include deriving orthogonal parts of the channel matrix and forming a new channel matrix based on the parts.

The method may further include forming a new channel matrix from the channel matrix and characteristics of the channel noise.

1. A method for determining a signal vector comprising a plurality of components from a received signal vector comprising
generating an estimation of the signal vector;
determining a channel matrix characterizing the communication channel via which the signal vector was received;
carrying out a plurality of determination iterations based on the channel matrix, wherein for each iteration
a first set of possible sub-vectors of the signal vector is determined based on a second set of possible sub-vectors for the previous iteration and
from the first set of possible sub-vectors, a number of sub-vectors is selected based on the distance of the sub-vectors to the estimated signal vector according to a pre-selected metric to form a strict subset of the first set as the second set of possible sub-vectors for the iteration;
determining the signal vector based on a possible sub-vector for the last iteration.

2. The method according to claim 1, wherein the estimation of the signal vector is generated based on the zero forcing solution or the minimum mean square error solution.

3. The method according to claim 1, wherein the pre-selected metric is the Euclidean distance.

4. The method according to claim 1, wherein the determination iterations are carried out based on a QR decomposition of the channel matrix.

5. The method according to claim 1, wherein the first set of possible sub-vectors is determined based on at most a pre-determined number of elements of the second set for the previous iteration.

6. The method according to claim 1, wherein the second set is formed from the first set such that if a first sub-vector of the first set is selected to be in the second set and there is a second sub-vector in the first set that is closer to the estimated signal vector according to the pre-selected metric then the second sub-vector is also selected to be in the second set.

7. The method according to claim 1, wherein the possible sub-vectors of an iteration have a dimension that is one higher than the sub-vectors of the previous iteration.

8. The method according to claim 1, wherein the possible sub-vectors of the first set for an iteration are determined from the sub-vectors of the second set for the previous iteration such that each sub-vector of the first set includes one of the sub-vectors of the second set for the previous iteration as a sub-vector.

9. The method according to claim 8, each sub-vector of the first set includes one of the sub-vectors of the second set for the previous iteration as a sub-vector and an additional component.

10. The method according to claim 9, wherein the additional component at least partially specifies a possible component of the transmitted signal vector.

11. The method according to claim 10, wherein the additional component at least partially specifies a constellation symbol according to a modulation scheme.

12. The method according to claim 1, wherein the channel matrix includes noise information.

13. The method according to claim 1, wherein the signal vector was transmitted using a plurality of transmit antennas and the received signal vector was received using a plurality of receiving antennas.

14. The method according to claim 13, wherein for each pair of a transmit antenna and a receiving antenna, the channel matrix includes information about transmission characteristics between the transmit antenna and the receiving antenna.

15. A detection circuit for determining a signal vector comprising a plurality of components from a received signal vector comprising
a generating circuit configured to generate an estimation of the signal vector;
a first determining circuit configured to determine a channel matrix characterizing the communication channel via which the signal vector was received;
a processing circuit configured to carry out a plurality of determination iterations based on the channel matrix, wherein for each iteration
a first set of possible sub-vectors of the signal vector is determined based on a second set of possible sub-vectors for the previous iteration and
from the first set of possible sub-vectors, a number of sub-vectors is selected based on the distance of the sub-vectors to the estimated signal vector according to a pre-selected metric to form a strict subset of the first set as the second set of possible sub-vectors for the iteration;
a second determining circuit configured to determine the signal vector based on a possible sub-vector for the last iteration.

16. A computer program product which, when executed by a computer, makes the computer perform a method for determining a signal vector comprising a plurality of components from a received signal vector comprising
generating an estimation of the signal vector;
determining a channel matrix characterizing the communication channel via which the signal vector was received;
carrying out a plurality of determination iterations based on the channel matrix, wherein for each iteration
a first set of possible sub-vectors of the signal vector is determined based on a second set of possible sub-vectors for the previous iteration and
from the first set of possible sub-vectors, a number of sub-vectors is selected based on the distance of the sub-vectors to the estimated signal vector according to a pre-selected metric to form a strict subset of the first set as the second set of possible sub-vectors for the iteration;
determining the signal vector based on a possible sub-vector for the last iteration.
